(19) United States
(12) Patent Application Publication
(10) Pub. No.: US 2006/0176278 A1
(43) Pub. Date: Aug. 10, 2006

(54) Method and system for display orientation

(75) Inventors: Ajit Mathews, Plantation, FL (US); Julio C. Castaneda, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/055,219

(22) Filed: Feb. 10, 2005

(51) Int. Cl. G09G 5/00

(52) U.S. Cl. 345/168

(57) ABSTRACT

A system (10 or 80) for orienting a display image and mapping key functions includes a sensor portion (86) for sensing at least one characteristic of an object and a processor (84). The processor can be programmed to determine an orientation and orient a display image including a soft key function (81, 83, 85, 87, 95, 96, 97 or 98) relative to the determined orientation of the object. The processor can alter the function of the soft key function by remapping at least one soft key function based on the determined orientation of the object. Optionally, the processor alters the function of the soft key function by remapping a set of switches lying underneath a display (25 or 82). The processor can be further programmed to enable user selective reorienting (114) of the display image by (for example) enabling the selection of a key in a non-active zone.

### FIELD OF THE INVENTION

This invention relates generally to user interfaces, and more particularly to a method and system for orienting displays and keys.

### BACKGROUND OF THE INVENTION

Current handset devices that have a flip or pivoting or other moving display can in some instances be rotated in some or all of the x, y and z axes to facilitate various operations like camera picture mode or gaming console mode. Since many of these devices are menu and softkey driven, a lack of flexibility in reorienting or redefining keys in correspondence to the orientation of the display creates confusion among users. For example, if the flip on a flip phone was oriented or rotated on the Z axis, the softkeys on the handset base of the flip phone will likely not be easily accessed for various handset operations. There appears to be no existing multi-axis display device that remaps softkeys or other function keys for ease of use as the display is re-oriented on one axis or another.

### SUMMARY OF THE INVENTION

Embodiments in accordance with the present invention can provide methods and systems to ease the display orientation and active key functions based on a display orientation using a combination of software and hardware.

In a first embodiment of the present invention, a method for orienting a display image and mapping key functions can include the steps of sensing at least one characteristic of an object, determining an orientation of the object from at least one of the sensed characteristics of the object, orienting the display image relative to the determined orientation of the object, and altering at least one key function (such as a soft key function) based on the determined orientation of the object. If the display image is on a display on a flip portion of a clam shell shaped product, the sensing of a characteristic can involve sending an orientation of the flip portion. Note, the step of altering the at least one soft key function can include remapping the at least one soft key function based on the determined orientation of the object. The step of altering at least one soft key function can also include remapping a set of switches lying underneath a display. The method can also include the step of user selectively reorienting the display image for example, by selecting a key in a non-active zone on a display.

In a second embodiment of the present invention, a system for orienting a display image and mapping key functions can include a sensor portion for sensing at least one characteristic of an object and providing a sensor signal indicative of the at least one characteristic and a processor. The processor can be programmed to receive the sensor signal, determine an orientation of the object from the sensor signal, and orient the display image including a soft key function relative to the determined orientation of the object. The processor can alter the function of the soft key function by remapping the at least one soft key function based on the determined orientation of the object. Optionally, the processor alters the function of the soft key function by remapping a set of switches lying underneath a display. Also, the processor can be further programmed to alter a function of the soft key function relative to the determined orientation of the object. The processor can be further programmed to enable user selective reorienting of the display image by (for example) enabling the selection of a key in a non-active zone on a display. Note, the sensor portion can sense the orientation of a flip portion on a clam shell shaped product in one embodiment and in other embodiments the sensor portion can sense the orientation of a display that can pivot on multiple axes.

In a third embodiment of the present invention, an electronic product can include a display, a sensor portion for sensing one among a predetermined number of orientations for the display, and a plurality of function keys associated with the display. Sets of keys among the plurality of keys can be dynamically associated and remapped in accordance with the predetermined number of orientations of the display. The display can pivot on multiple axes. The electronic product can further include a processor programmed to receive a sensor signal, determine an orientation of the display from the sensor signal and orient a display image including a soft key function relative to the determined orientation of the display. The processor can be further programmed to alter a function of the soft key function relative to the determined orientation of the object such as by remapping a set of switches lying underneath the display. The electronic product can be a cellular phone, a camera phone, a video phone, a camera, a personal digital assistant, or a laptop computer for example.

Other embodiments, when configured in accordance with the inventive arrangements disclosed herein, can include a machine readable storage for causing a machine to perform the various processes and methods disclosed herein.

### BRIEF DESCRIPTION OF THE DRAWINGS

FIG. 1 is an illustration of an electronic product in a closed position having a display that can be oriented in multiple axes in accordance with an embodiment of the present invention.

FIG. 2 is another illustration of the electronic product of FIG. 1 open on a first x axis in accordance with an embodiment of the present invention.

FIG. 3 is another illustration of the electronic product of FIG. 1 rotating on a z axis in a first direction accordance with an embodiment of the present invention.

FIG. 4 is another illustration of the electronic product of FIG. 1 rotating on the z axis in a second direction in accordance with an embodiment of the present invention.

FIG. 5 is another illustration of the electronic product of FIG. 1 open on a second x axis in accordance with an embodiment of the present invention.

FIG. 6 is another illustration of the electronic product of FIG. 1 open on a first y axis in accordance with an embodiment of the present invention.

FIG. 7 is another illustration of the electronic product of FIG. 1 open on a second y axis in accordance with an embodiment of the present invention.

FIG. 8 is an illustration of another electronic device having a moving display and softkeys in accordance with an embodiment of the present invention.

FIG. 9 is the electronic device of FIG. 8 illustrating a reorienting of a display and a corresponding remapping of softkeys for an application in accordance with an embodiment of the present invention.

FIG. 10 is the electronic device of FIG. 8 illustrating a reorienting of a display and a corresponding remapping of softkeys when switching applications in accordance with an embodiment of the present invention.

FIG. 11 is the electronic device of FIG. 10 shown in a different orientation with a corresponding remapping of softkeys in accordance with an embodiment of the present invention.

FIG. 12 is a flow chart illustrating a method for orienting a display image and mapping key functions with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

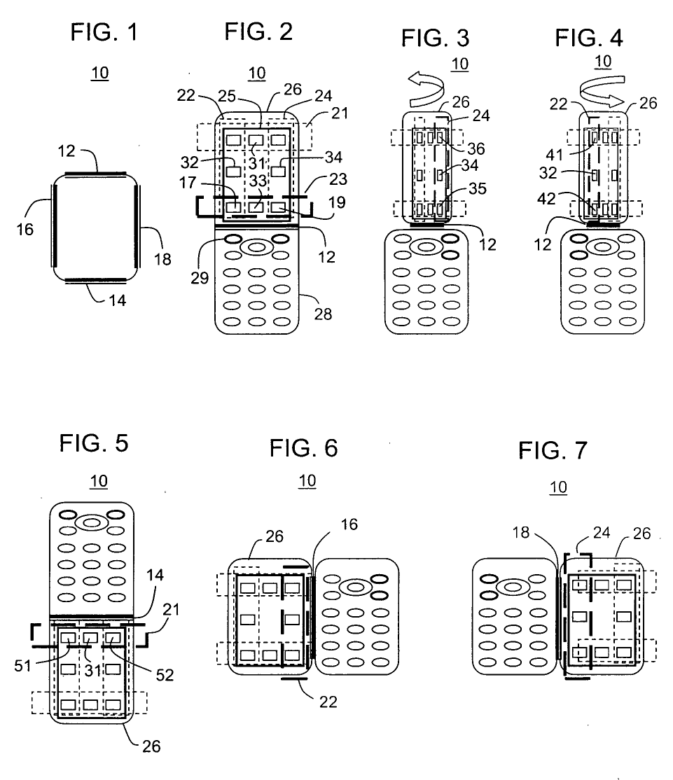

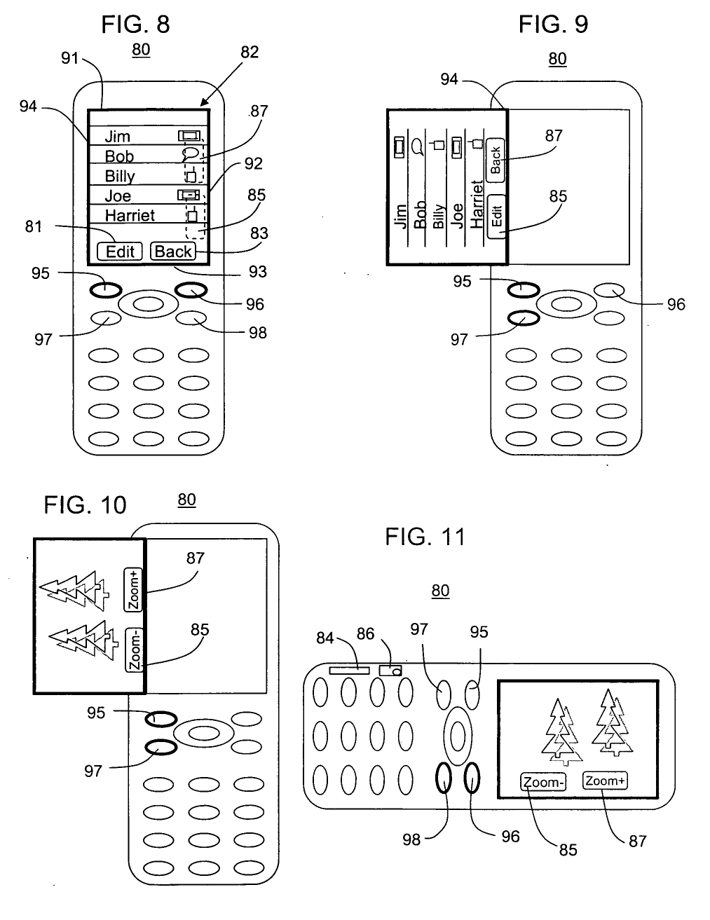

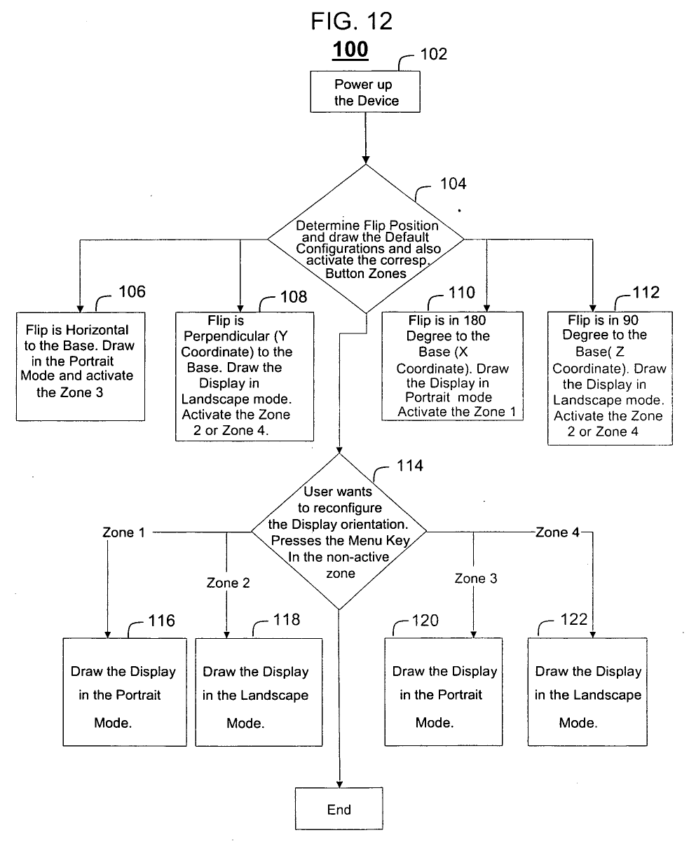

Referring to FIG. 1, an electronic product 10 such as a cellular phone, a camera phone, a camera, a personal digital assistant, a laptop computer or almost any portable electronic device having a movable display is represented in a closed orientation. Although the example of the electronic product shown in FIGS. 1-7 is in a clam shell or flip style, embodiments herein are not limited to such construction as demonstrated by the monolith shaped device shown in FIGS. 8-11. In the embodiment of the electronic product 10, a flip portion 26 as illustrated in FIGS. 2-7 can pivot or move in x, y or z coordinates along axes 12, 14, 16, or 18.

More specifically referring to FIG. 2, the electronic product 10 can include a flip portion 26 coupled to a base portion 28 at an axis 12. The base portion 28 can include a plurality of keys 29 that can be used as softkeys in certain embodiments corresponding to iconic keys displayed on a display 25. The flip portion can incorporate the display 25 and can rotate or flip about the axis 12. The display 25 can also include a plurality of keys in a plurality of zones. These keys can be iconic softkeys corresponding or mapping to the plurality of keys 29 or they can be switches beneath the display such as the type found in touch pad displays. A first zone 21 or “zone 1” can include at least one key 31, a second zone 22 or “zone 2” can include at least one key 32, a third zone 23 or “zone 3” can include at least one key 33, and a fourth zone or “zone 4” can include at least one key 34. In one embodiment, keys 31, 32, 33, and 34 can serve as menu keys depending on the orientation and in another embodiment these keys can enable a user to selectively reorient the display image. In the orientation shown, the key 33 as well as keys 17 and 19, all in zone 23, are active. The display image can be in a portrait mode. Further note that the orientation or the flip and corresponding display can be determined by sensors or switches that can be embedded in the respective axes.

As the flip portion 26 is rotated in a z coordinate to the right or in a counter-clockwise fashion as shown in FIG. 3, the keys 34, 35 and 36 in zone 24 can be activated (and remapped) to enable a more user friendly operation of the electronic product 10. Likewise, as the flip portion 26 is rotated in the z coordinate to the left or in a clockwise fashion as shown in FIG. 4, the keys 32 as well as keys 41 and 42 in zone 22 can be activated (and remapped) to enable a better and more intuitive user experience. In both instances as shown in FIGS. 3 and 4, the display image can be in a landscape mode.

As shown in FIG. 5, if the flip portion 26 and corresponding display were to able to rotate about a second horizontal or x axis 14, then keys 3 1 as well as keys 51 and 52 in zone 21 can be activated and remapped. In this instance, the display image can be in a portrait mode. In FIG. 6, the flip portion 26 is shown pivoting around a first vertical or y axis 16. In this case, the keys in zone 22 can be activated and mapped to operate with an application running on the product 10. Likewise, in FIG. 7, the flip portion 26 is shown pivoting around a second vertical or y axis 18 with the keys in zone 24 being activated and mapped to operate in conjunction with the application running on the product 10. The product 10 in FIGS. 6 and 7 can have a display image in a landscape mode. Finally, note that not only can the keys on or behind the display 25 can be reoriented and remapped, but the keys 29 can also be correspondingly reoriented and/or remapped. The keys 29 in bold in FIGS. 2-7 show an exemplary mapping of keys that can change with the orientation of the display. Of course, the mapping) shown is merely all example and other mappings can be done as contemplated in the scope and spirit of the claims herein.

Referring to FIGS. 8-11, another electronic device 80 demonstrates alternative embodiments in a monolith shaped device such as a phone that still has a display that can move and reorient. The display 82 can be designed to rotate around an x axis 94 or another x axis 92, a y axis 91 or another y axis 93. In an alternative arrangement, the display 82 can move in another manner to reorient, for example, it can “pop-up” and shift in one direction or another. The display 82 can also include softkeys 81, 83, 85 and 87 for example. These keys can correspond and map to (hardware) keys 95, 96, 97 and 98 on the device 80. As shown in FIG. 8, the display 82 can run an application such as a phonebook application in a portrait mode and then can rotate around the axis 94 (or pop-up and shift in an alternative embodiment) to orient the display as shown in FIG. 9. In FIG. 9, the same application (phonebook application) active in FIG. 8 in a portrait mode can operate in an landscape mode. Correspondingly, the “edit” and “back” softkeys 81 and 83 can be reoriented and remapped to softkeys 85 and 87 respectively. Likewise, hardware keys 95 and 96 operating in the portrait mode can be reoriented and remapped to hardware keys 97 and 95 respectively operating in the landscape mode. Note that the application does not necessarily need to be the same when reorienting and remapping. For example, the electronic device can go from one orientation and application such as the phonebook application shown in FIG. 8 to another orientation and application such as a camera mode as illustrated in FIG. 10. Note, the keys 85 and 87 in a camera application are mapped for zooming-out and zooming-in respectively instead of an “edit” and “back” function.

Referring to FIG. 11, another embodiment can merely detect another orientation of the electronic device 80 (instead of the display 82) and remap the keys (either softkeys or hardware keys or both) to provide an intuitive operation that can help users maneuver through applications and menus. In this instance, a sensor or sensors such as a mercury switch 86 coupled to a processor 84 can be used to determine orientation of the device 80. In FIG. 10, the keys 97 and 95 can be coded to perform the zoom-in and zoom-out functions when the device 80 is in a vertical position as shown. If the device 80 is then placed in a horizontal orientation as shown in FIG. 1 1, then the keys 98 and 96 can be remapped (from keys 97 and 95) to perform the zoom-in and zoom-out functions. This arrangement might be more intuitive to a user. Of course, the image displayed can be reoriented as well when the device itself is reoriented, but not necessarily as illustrated by the examples of FIGS. 10 and 11.

As noted above, the keys on the display can be merely iconic or that can include actual mechanical switches under the display in one embodiment. The center buttons in each zone can act as a Menu Key and the side buttons or keys can act as the soft keys. In response to the user key presses these switches will generate the signals that will be transferred to the software for corresponding high and low signals. If the keys are grouped into four zones for example as illustrated in FIGS. 2-7, the a software algorithm can be used to figure out the actual set of zones that will be active depending upon the display or device orientation. These zones can be dynamically configured on the fly so as to assist the user. In one embodiment, an extended Menu press in a non active zone can cause the display image and corresponding keys to go from a landscape mode to a portrait mode or from a portrait mode to a landscape mode. Thus, the software can enable the rotation of the display content in any orientation (landscape or portrait in most instances). The software can also relay out the display content depending on the display orientation and can further respond to user key presses and launch appropriate applications.

Using the techniques discussed above, a display can be oriented in any direction and a user can still intuitively and easily access softkeys and menus keys regardless of the display orientation. Furthermore, a user can also selectively orient the display image if desired by pressing a key such as a menu key or softkey. Using software, a user can also dynamically change the display layout and key mapping on the fly if desired. In the embodiments where mechanical switches are underneath the display, the display can be thought of as a pseudo touch panel since not all of the display would be responsive to touch.

In yet another embodiment, a sample method 100 for orienting a display image and mapping key functions is illustrated in a flow chart. The method 100 can begin by powering up the device at step 102 and determining or sensing at least one characteristic of an the device at decision block 104. More specifically, at decision block 104, a determination of an orientation of the display by determining the flip position can be done. Note, several alternatives can happen based on the orientation of the device or display. At step 106, if the flip is horizontal to the base, then the display image can be drawn in a portrait mode and a third zone 23 (of keys) can be activated (See FIG. 2). At alternative step 108, if the flip is perpendicular (y coordinate) to the base, then the display image can be drawn in an landscape mode where either a second zone 22 or a fourth zone 24 (of keys) can be activated (See FIGS. 6 or 7 respectively). At alternative step 110, if the flip is in a 180 degree angle relative to the base along a second x axis as shown in FIG. 5, then the display image can be drawn in a portrait mode and a first zone 21 of keys can be activated. If the flip is in a substantially 90 degree angle to the base (along a z coordinate or axis), then the display image can be drawn in a landscape mode with either keys in the second zone 22 activated (as in FIG. 4) or with keys in the fourth zone 24 activated (as in FIG. 3).

Optionally, if the user wants to reconfigure the display image orientation at decision block 114, then the user can press a menu key or softkey in a non-active zone to implement the reconfiguration. If the user selects the first zone at step 116 or the third zone at step 120 when such zones are inactive, then the display image will be oriented in a portrait mode. If the user selects the second zone at step 118 or the fourth zone at step 122, then the display image is oriented in a landscape mode. Otherwise, the method 100 ends

In light of the foregoing description, it should be recognized that embodiments in accordance with the present invention can be realized in hardware, software, or a combination of hardware and software. A system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method for orienting a display image and mapping key functions, the method comprising the steps of:
sensing at least one characteristic of an object;
determining an orientation of the object from at least one of the at least one sensed characteristic;
orienting the display image relative to the determined orientation of the object; and
altering at least one soft key function based on the determined orientation of the object.

2. The method of claim 1, wherein the step of sensing comprises sensing an orientation of a flip portion on a clam shell shaped product.

3. The method of claim 1, wherein the step of altering the at least one soft key function comprises the step of remapping the at least one soft key function based on the determined orientation of the object.

4. The method of claim 1, wherein the step of altering the at least one soft key function comprises the step of remapping a set of switches lying underneath a display.

5. The method of claim 1, wherein the method further comprises the step of user selectively reorienting the display image.

6. The method of claim 5, wherein the step of user selectively reorienting the display image comprises the step of selecting a key in a non-active zone on a display.

7. A system for orienting a display image and mapping key functions, the system comprising:
a sensor portion for sensing at least one characteristic of an object and providing a sensor signal indicative of the at least one characteristic; and
a processor programmed to:
receive the sensor signal;
determine an orientation of the object from the sensor signal; and
orient the display image including a soft key function relative to the determined orientation of the object.

8. The system of claim 7, wherein the processor is further programmed to alter a function of the soft key function relative to the determined orientation of the object.

9. The method of claim 8, wherein the processor alters the function of the soft key function by remapping the at least one soft key function based on the determined orientation of the object.

10. The system of claim 8, wherein the processor alters the function of the soft key function by remapping a set of switches lying underneath a display.

11. The system of claim 7, wherein the sensor portion senses an orientation of a flip portion on a clam shell shaped product.

12. The system of claim 7, wherein the system further comprises a display that can pivot on multiple axes.

13. The system of claim 7, wherein the processor is further programmed to enable user selective reorienting of the display image.

14. The system of claim 13, wherein the processor user selectively reorients the display image by enabling the selection of a key in a non-active zone on a display.

15. An electronic product, comprising:
a display;
a sensor portion for sensing one among a predetermined number of orientations for the display; and
a plurality of function keys associated with the display, wherein sets of keys among the plurality of keys are dynamically associated and remapped in accordance with the predetermined number of orientations of the display.

16. The electronic product of claim 15, wherein the electronic product further comprises a processor programmed to receive a sensor signal, determine an orientation of the display from the sensor signal and orient a display image including a soft key function relative to the determined orientation of the display.

17. The electronic product of claim 16, wherein the processor is further programmed to alter a function of the soft key function relative to the determined orientation of the object.

18. The electronic product of claim 17, wherein the processor is further programmed to alter the function of the soft key function by remapping a set of switches lying underneath the display.

19. The electronic product of claim 15, wherein the electronic product is selected among a cellular phone, a camera phone, a video phone, a camera, a personal digital assistant, and a laptop computer.

20. The electronic product of claim 15, wherein the display can pivot on multiple axes.
